(19) United States
(12) Patent Application Publication
(10) Pub. No.: US 2005/0232737 A1
(43) Pub. Date: Oct. 20, 2005

(54) Integrated pivot and conveyor drive shaft for an unloading door of a receiver of a cotton harvesting machine

(75) Inventors: Timothy A. Meeks, Davenport, IA (US); Michael J. Covington, Bettendorf, IA (US)

Correspondence Address: CNH AMERICA LLC, INTELLECTUAL PROPERTY LAW DEPARTMENT, 700 STATE STREET, RACINE, WI, 53404, US

(73) Assignee: CNH America LLC

(21) Appl. No.: 11/083,412

(22) Filed: Mar. 18, 2005

Related U.S. Application Data
(60) Provisional application No. 60/557,885, filed on Mar. 30, 2004.

(51) Int. Cl. B60P 1/00

(52) U.S. Cl. 414/525.1; 414/537

(57) ABSTRACT

An integrated door pivot and conveyor drive for an unloading door or ramp for a receiver for harvested crops such as a cotton receiver of a cotton harvesting machine. The integrated pivot and conveyor drive facilitates pivotability of the door or ramp, particularly conveyor chains and a floor of the door or ramp, relative to a floor of the receiver as the door or ramp is pivoted between a closed position angularly related to the floor of the receiver at about a 90° angle forming a closure, and an open position oriented coplanar with or parallel to and just below the floor of the receiver, forming a substantially continuous conveyor surface for conveying harvested crops from the receiver.

This application claims the benefit of U.S. Provisional Application No. 60/557,885, filed Mar. 30, 2004.

### TECHNICAL FIELD

This invention relates generally to an unloading door or ramp for a receiver for harvested crops such as a cotton receiver of a cotton harvesting machine, and more particularly, to an unloading door or ramp including an integrated pivot and conveyor drive shaft which facilitates pivotability of the door or ramp, particularly conveyor chains and a floor of the door or ramp, relative to a floor of the receiver as the door or ramp is pivoted between a closed position angularly related to the floor of the receiver at about a 90° angle, and an open position oriented coplanar with or parallel to and just below the floor of the receiver.

### BACKGROUND ART

Commonly, receivers for harvested crops, such as cotton receivers, and more particularly baskets and cotton compacting chambers of cotton module builders and packagers, include a live floor, that is, a floor including at least one conveyor such as a chain thereon for moving cotton, particularly, a compacted body or module of cotton, across the floor and through an open unloading doorway of the receiver and onto a conveyor surface of an unloading door or ramp. It is desirable for both the floor of the cotton receiver and the conveyor surface of the door or ramp to be smooth and provide a low friction surface for conveyance of the cotton thereover. The floor of the receiver and the conveyor surface of the door or ramp are also preferably substantially coplanar when the door or ramp is in an unloading or open position. Still further, there is preferably only a small space or gap between the floor of the receiver and the conveying surface of the door or ramp, such that the cotton, particularly, heavier compacted bodies or modules of cotton, which can weigh as much as about 11,000 pounds, can be smoothly conveyed from the floor to the door or ramp, without significant dragging, snagging or slowing of movement as a result of passage over any gap or space. It is further contemplated to provide an upper surface on the floor of the cotton receiver and on the conveying surface of the door or ramp, composed of a sheet or layer of a low friction material, and it would be important that with this surface or layer, the door or ramp be still capable of pivoting relative to the floor without interference. It is also important that the conveyor chains of the door or ramp be pivotable relative to the floor of the receiver without interference or other problems.

Therefore, what is sought is to provide one or more of the advantages and overcome one or more of the problems set forth above.

### SUMMARY OF THE INVENTION

What is disclosed is an integrated pivot and conveyor drive arrangement for a folding door or ramp for a receiver of a harvesting machine, such as a cotton module builder or packager of a cotton harvesting machine, which provides one or more of the advantages and overcomes one or more of the problems set forth above.

According to a preferred aspect of the invention, the receiver includes a live floor including at least one conveyor such as a chain extending in a predetermined direction toward an unloading door opening through which a harvested crop such as cotton is conveyed from the receiver. Each conveyor chain encircles sprockets including a sprocket supported on a drive shaft for rotation therewith located below the unloading door opening. An unloading door or ramp is pivotally connected to the cotton receiver for pivotal movement between a closed position enclosing at least a part of the unloading doorway, and an open position substantially parallel to the floor of the receiver. The door or ramp can be of one or more segments, and includes a conveying surface which faces upwardly when in the open position in at least substantially coplanar relation to the floor of the receiver. At least one conveyor chain extends from the floor to an opposite end of the door or ramp. At least one conveyor chain on the floor of the receiver and the at least one chain on the door or ramp adjacent the floor encircle sprockets mounted on a common drive shaft rotatable about an axis of rotation, and the door or ramp segment adjacent to the receiver is mounted, preferably on the drive shaft, for pivotal movement about the rotational axis between the open and closed positions.

According to another preferred aspect of the invention, a receiver for harvested crops is disclosed, including a receiver structure including a floor extending between opposite upstanding walls defining a chamber for receiving crops, the floor having a peripheral edge portion extending therealong between the walls, the edge portion of the floor and peripheral edges of the walls extending upwardly therefrom defining an opening connecting with the chamber, and the floor including at least one elongate endless first conveyor extending along the floor and over the edge portion thereof. The receiver includes a door having a surface adapted to be positioned in a closed position in covering relation to at least a lower portion of the opening along the edge portion of the floor for containing crops in the chamber, and in an open position extending outwardly from the opening generally parallel to the floor to serve a ramp for unloading crops from the chamber. The surface of the door has an end portion including an edge portion located adjacent to the edge portion of the floor, and at least one elongate endless second conveyor extending over the surface of the door and over the edge portion thereof. The receiver includes a combination door pivot and conveyor drive mechanism including a shaft supported on the receiver structure so as to extend at least substantially parallel to and below the edge portion of the floor transversely to the conveyors, the shaft being supported for rotation about a rotational axis extending longitudinally therethrough and including elements at least partially encircled by and cooperatively engaged with the first and second conveyors, such that when the shaft is rotated in a predetermined rotational direction the shaft will move the at least one first conveyor along the floor toward the edge portion thereof and the at least one second conveyor along the surface of the door away from the edge portion thereof. The combination door pivot and conveyor drive mechanism includes a drive connected in driving relation to the shaft and controllably operable for rotating the shaft in at least the predetermined rotational direction. The shaft pivotally connects the door to the receiver structure for pivotal movement of the door between the closed position and the open position such that when the door is in the closed position the surface of the door will be positioned in closely adjacent relation to at least a substantial portion of the edge portion of the floor, and such that when the door is in the open position the edge portion thereof will be at least substantially in edge-to-edge relation with the edge portion of the floor and the first and second conveyors will be partially longitudinally coextensive, providing a continuous surface structure and conveyor for unloading crop from the receiver structure.

According to another preferred aspect of the invention, the floor and surface of the door comprises a low friction material such as a low friction polymer, for smooth movement of compacted bodies of cotton thereover.

### BRIEF DESCRIPTION OF THE DRAWINGS

FIG. 1 is a simplified fragmentary side view of a cotton harvesting machine, including a cotton packager pivoted to an unloading position, and an associated ramp extending from a floor of the packager to a ground surface supported by an integrated pivot and conveyor chain drive shaft according to preferred aspects of the invention;

FIG. 2 is a simplified fragmentary perspective representation of the floor of the packager and the ramp, showing the integrated pivot and drive shaft;

FIG. 3 is another simplified fragmentary representation of the ramp, showing the relationship with the floor of the packager;

FIG. 4 is a simplified schematic representation showing the relationship of floor surfaces of the packager and the ramp;

FIG. 5 is a simplified schematic representation of the floor of the packager and surfaces of the ramp, showing the relationship between adjacent edges thereof;

FIG. 6 is a fragmentary view of the floor of the packager and the first ramp segment, with the floor sections removed to reveal the integrated pivot and conveyor chain drive shaft;

FIG. 7 is a fragmentary top view showing the floor of the packager and the first door segment, the pivot and the drive shaft, and representative conveyor chains;

FIG. 8 is a simplified side view showing the integrated pivot and drive shaft with the first ramp segment in its open position; and

FIG. 9 is a simplified side view showing the integrated pivot and drive shaft with the first ramp segment in its closed position.

### DETAILED DESCRIPTION OF THE INVENTION

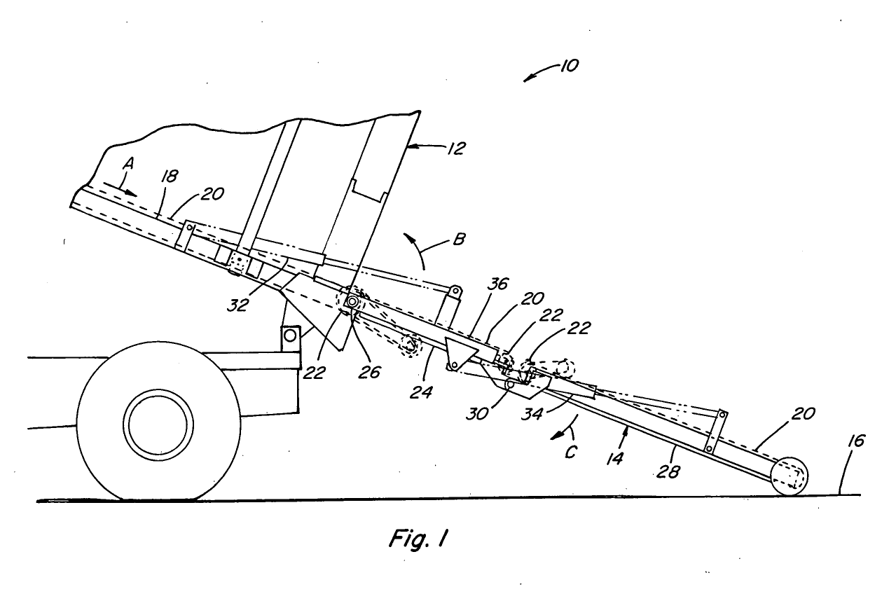

Referring now to the drawings, in FIG. 1, a rear end of a cotton harvesting machine 10 is shown, including a cotton packager 12 of the machine tilted to an unloading position in the well known conventional manner, and an unloading ramp 14 extending rearwardly and downwardly from packager 12 to a ground surface 16, in an unloading position. Cotton packager 12 includes an interior that defines a cotton compacting chamber for receiving cotton from harvesting units (not shown) of machine 10 and in which the harvested cotton is compacted into a unitary body or module of cotton (also not shown) in the well known conventional manner. It should be noted that for the purposes herein, the terms ramp and door are considered to be interchangeable, and that the term packager is to also encompass a cotton module builder and also a basket, and is to be considered to be representative of other receivers for harvested crops.

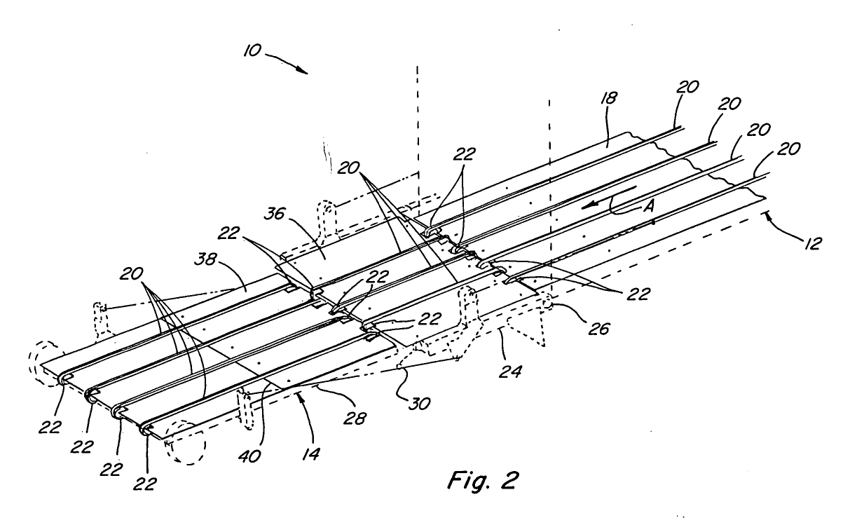

Referring also to FIG. 2, the bottom of the cotton compacting chamber of packager 12 is defined and enclosed by an upwardly facing floor surface 18 comprised of one or more sheets of a low friction polymer material, such as, but not limited to, sheets available from Alert Manufacturing and Supply Co. of West Des Moines, Iowa. A plurality of conveyor chains 20 extend forwardly and rearwardly in spaced relation one to the other over floor surface 18 and encircle sprockets 22. Conveyor chains 20 and sprockets 22 are rotatably drivable using a suitable drive mechanism, which can include a motor, such as, but not limited to, a fluid or electric motor, for moving chains 20 in a predetermined unloading direction, denoted by arrow A, over floor surface 18, for conveying a compacted body or module of cotton from the interior of the chamber.

Floor 18 can comprise a plurality of individual sheets of the low friction polymer material disposed between conveyor chains 20, or one or more larger sheets, and can be located beneath chains 20 for providing a low friction supporting surface therefor. Alternatively, several elements such as channeled guides or the like can be provided beneath chains 20, as desired.

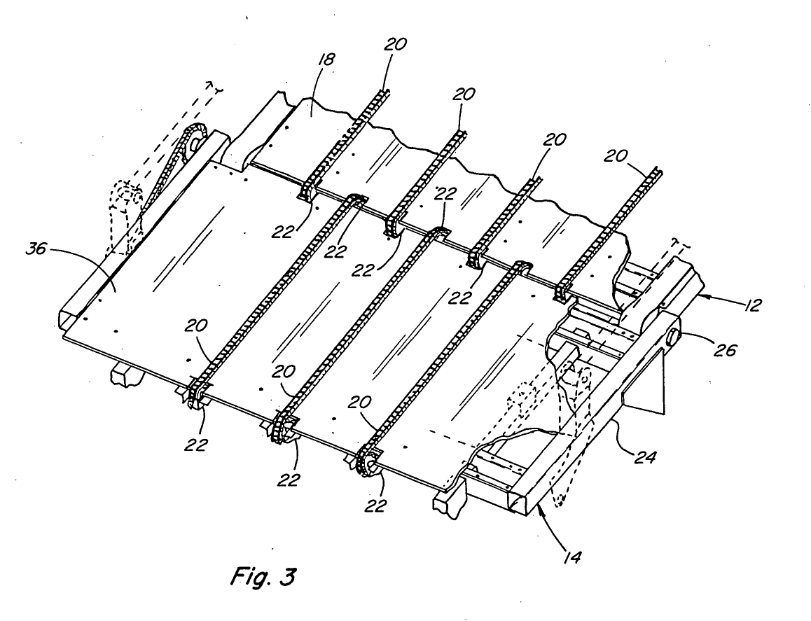

Referring also to FIGS. 3, 4 and 5, unloading ramp 14 includes a first segment 24 pivotally connected at a pivot 26 to the rearward end of cotton packager 12 for pivotal movement between an unloading or open position as shown, and a closed position (not shown) in covering relation to the rearward end of packager 12. Ramp 14 additionally includes a second ramp segment 28 pivotally connected at pivot 30 to first ramp segment 24 for pivotal movement relative to first ramp segment 24 and packager 10, as denoted by arrow B, between the unloading position as shown, and a folded position beside first ramp segment 24 when in its closed position, as denoted by arrow C in FIG. 1. Pivotal movement of first and second ramp segments 24 and 28 is effected, respectively, by fluid cylinders 32 and 34, in the well known manner. First ramp segment 24 includes an upwardly facing floor or conveyor surface 36 which preferably comprises one or more low friction polymer sheets, such as of the above described material, for low friction movement of a compacted body of cotton thereover. Similarly, second ramp surface 28 has a conveyor surface 38 preferably composed of the same material. Each of the ramp segments 24 and 28 includes a plurality of conveyor chains 20 encircling sprockets 22 at the opposite ends of the segment for conveying the cotton thereover. The polymer sheets of surfaces 36 and 38 can support chains 20 in the above-described manner, or separate channels or other elements can be used. Additionally, surfaces 36 and 38 can each comprise a single large sheet of the low friction material, or two or more pieces as desired. For example, referring to FIG. 2, conveyor surface 38 of ramp segment 28 is shown including two sheets of the material which each extend the full width of the ramp, and abut or overlap at line 40.

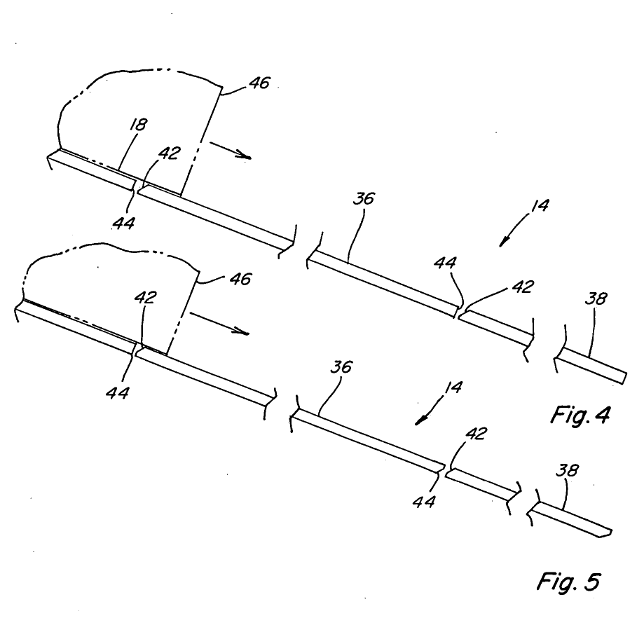

Referring more particularly to FIG. 4, proximal edges 42 and 44 of the low friction sheets of surfaces 18, 36 and 38 are shown, for the smooth movement and transition of a compacted body of cotton thereof, denoted by cotton module 46. Essentially, by providing an upwardly facing bevel or edges 42 on the downstream edge of the surface 36 and/or 38, a smooth transition of the compacted body of cotton thereover is achieved, without tearing and/or slowing the movement of the cotton thereover. Bevels 42 and the location of pivot 26 also ensure that when pivoted between the closed and unloading positions, interference between the surfaces is avoided.

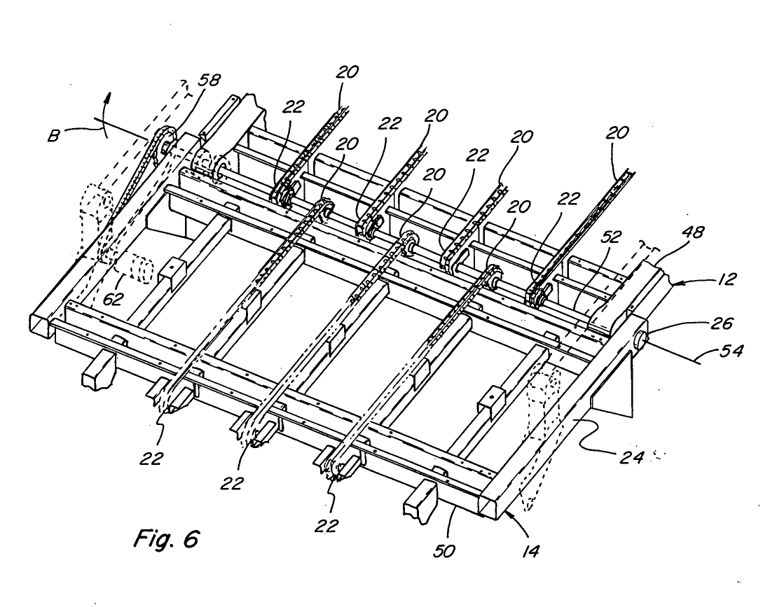

Referring also to FIG. 6, cotton packager 12 and first ramp segment 24 are shown with floor surface 18 and conveyor surface 36 removed, to show a floor frame 48 of packager 12 for supporting surface 18, and a frame 50 of ramp segment 24 for supporting conveyor surface 36. Importantly, also better shown is pivot 26 for pivotally connecting ramp segment 24 to floor frame 48, integrated with a conveyor drive shaft 52 on which sprockets 22 are mounted. Integrated pivot 26/drive shaft 52 are rotatable about an axis of rotation 54 therethrough. Ramp segment 24 and packager 12 are relatively pivotable about axis of rotation 54, such that ramp segment 24 is oriented at about a 90° angle to floor frame 48, as denoted by the arrow B.

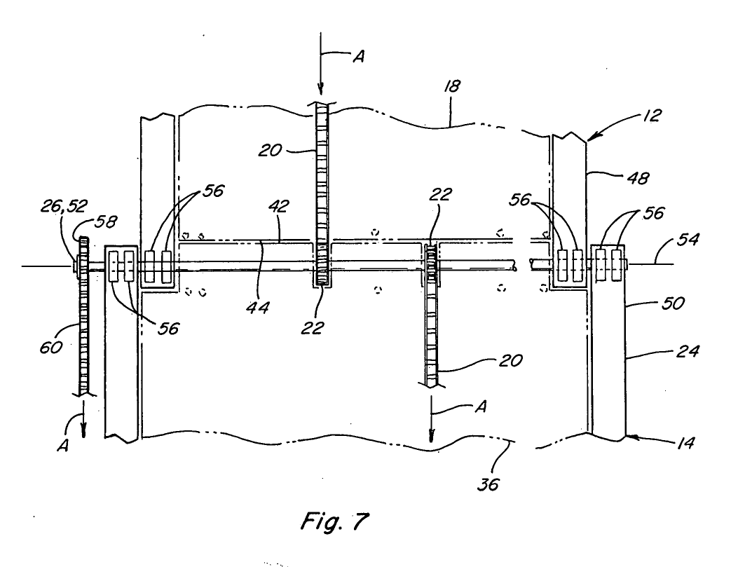

Referring also to FIG. 7, a top view of the pivotal connection of first ramp segment 24 of ramp 14 to cotton packager 12 is shown, including bearings 56 in members of floor frame 48 which support pivot 26/drive shaft 52 for rotation relative thereto. Frame 50 of door segment 24 also includes bearings 56 which are supported on pivot 26/drive shaft 52 to allow relative rotation thereof. Referring also to FIG. 6, drive shaft 52 includes a drive sprocket 58 enmeshed with a drive chain 60, which is rotatable by a suitable power source or motor 62, such as a fluid motor, electric motor or the like, as denoted by arrow A, for moving sprockets 22 and conveyor chains 20 in the direction A over the floor surface of both the packager and the conveyor surface of the door segment, as explained above. Motor 62, when not powered, is preferably freely rotatable by drive chain 60, when door segment 24 is pivoted between its open and closed positions, such that conveyor chain 20 is not moved by the pivoting of the door.

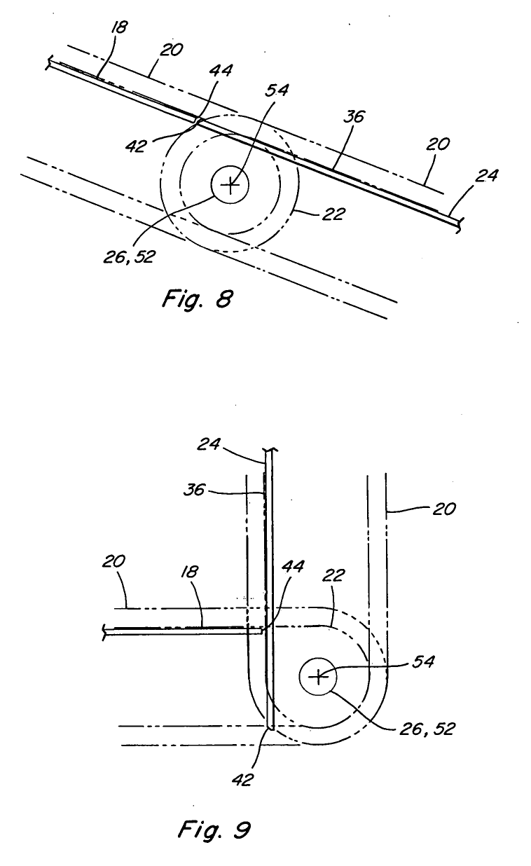

Referring also to FIG. 8, door segment 24 is illustrated pivoted about axis 54 of pivot 26/drive shaft 52 to its open or unloading position. In this position, conveyor surface 36 is generally coplanar to floor surface 18, or parallel therewith and just therebelow, edge portions 42 and 44 are shown in adjacent relation, and chains 20 and sprockets 22 are illustrated. As a result, a substantially continuous surface exists over floor surface 18 and conveyor surface 36, for the smooth conveyance and unloading of a body of cotton therefrom. Here also, viewing FIGS. 7 and 8, it should be observed that at sprockets 22, conveyor chains 20 on the surfaces 18 and 36 are longitudinally coextensive, such that uninterrupted conveyance of cotton thereby is facilitated.

Referring to FIG. 9, door segment 24 is shown pivoted about axis 54 to its closed position at about a 900 angle to floor 18, edge portions 42 and 44 now being spaced one from the other. When pivoted in this manner about pivot 26/drive shaft 52, it can be observed that no interference between edges 42 and 44 of surfaces 18 and 36 has occurred. It can also be observed in the previous drawings that suitable notches will be provided in surfaces 18 and 36 for free movement of chains 20 and sprockets 22 relatively thereto. In this position also, it can be observed that surface 36 is in close proximity to the edge of surface 18, so as to provide or serve as a barrier to passage of cotton therebetween and to provide a solid corner for the compaction of cotton thereagainst. Additionally, when door segment 24 is being pivoted between the positions of FIGS. 8 and 9, surface 36 will remain relatively close to edge portion 44 such that loose cotton is less likely to pass between edges.

Still further, sprockets 22 are preferably all of about the same diametrical extent, such that when drive shaft 52 is rotated, conveyor chains 20 on both surfaces 18 and 36 will be rotated simultaneously and at about the same speed. As a result, a cotton module will be smoothly conveyed thereover.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. A receiver for harvested crops, comprising:
a receiver structure including a floor extending between opposite upstanding walls defining a chamber for receiving crops, the floor having a peripheral edge portion extending therealong between the walls, the walls including peripheral edge portions extending upwardly from the edge portion of the floor, the edge portion of the floor and edge portions of the walls defining an opening connecting with the chamber, the receiver structure further including at least one elongate endless first conveyor extending along the floor and over the edge thereof;
a door having a surface adapted to be positioned in a closed position in covering relation to at least a lower portion of the opening along the edge portion of the floor for containing crops in the chamber, and in an open position extending outwardly from the opening generally parallel to the floor to serve a ramp for unloading crops from the chamber, the surface of the door having an end portion including an edge portion located adjacent to the edge portion of the floor, and at least one elongate endless second conveyor extending over the surface of the door and over the edge portion thereof; and
a combination door pivot and conveyor drive mechanism including a shaft supported on the receiver structure so as to extend at least substantially parallel to and below the edge portion of the floor transversely to the conveyors, the shaft being supported for rotation about a rotational axis extending longitudinally therethrough and including elements at least partially encircled by and cooperatively engaged with the first and second conveyors, such that when the shaft is rotated in a predetermined rotational direction the shaft will move the at least one first conveyor along the floor toward the edge portion thereof and the at least one second conveyor along the surface of the door away from the edge portion thereof, a drive connected in driving relation to the shaft and controllably operable for rotating the shaft in at least the predetermined rotational direction, and the shaft pivotally connecting the door to the receiver structure for pivotal movement of the door between the closed position and the open position such that when the door is in the closed position the surface of the door will be positioned in closely adjacent relation to at least a substantial portion of the edge portion of the floor, and such that when the door is in the open position the edge portion thereof will be at least substantially in edge-to-edge relation with the edge portion of the floor and the first and second conveyors will be partially longitudinally coextensive, providing a continuous surface structure and conveyor for unloading crop from the receiver structure.

2. The receiver of claim 1, wherein the drive is mounted on the door and the drive is selected from a group consisting of an electric motor and a fluid motor.

3. The receiver of claim 1, wherein the floor and the surface of the door are located a predetermined distance from the rotational axis of the shaft.

4. The receiver of claim 1, wherein the end portion of the surface of the door is positioned to be located in closely spaced relation to the edge portion of the floor when pivotally moving between the open position and the closed position, for limiting passage of crop material therebetween.

5. The receiver of claim 1, wherein the first conveyor extends from the floor outwardly through the opening, and the elements encircled by and cooperatively engaged with the first conveyor are located at least substantially outwardly of the opening and extend through slots in the surface of the door.

6. The receiver of claim 1, wherein the first and second conveyors each comprise a chain, and the elements at least partially encircled thereby each comprise a sprocket, the drive further including an endless chain which at least partially encircles a sprocket on the shaft, the chains of the second conveyor and the drive being rotatable about the sprockets during movement of the door between the open and closed positions.

7. The receiver of claim 1, wherein the floor and the surface of the door each comprise a low friction polymer material.

8. The receiver of claim 1, wherein the edge portion of the surface of the door includes an upwardly facing bevel for smooth transition of crops moving from the floor to the surface of the door.

9. The receiver of claim 1, wherein the receiver structure is mounted for pivotal movement on a crop harvesting machine between a first position wherein the floor is substantially horizontal, and a second position wherein the floor is tilted at an acute angle relative to horizontal of less than about 25 degrees.

10. The receiver of claim 1, wherein the receiver structure comprises a cotton receiver of a cotton module builder or packager operable for compacting cotton into a unitary body of compacted cotton having a weight of up to about 11,000 pounds, and is tiltable between a first position wherein the floor is substantially horizontal, and a second position wherein the floor is tilted at an acute angle relative to horizontal of up to about 25 degrees, the door being adapted for supporting and conveying the unitary body of cotton thereover.

11. A receiver for a cotton harvesting machine, comprising:
a receiver structure including a floor and walls extending upwardly therefrom defining a chamber for receiving harvested cotton, the floor and walls each including peripheral edge portions, the peripheral edge portion of the floor and the peripheral edge portions of opposing ones of the walls extending upwardly from opposite ends of the edge portion of the floor defining an opening connecting with the chamber, and a plurality of substantially parallel, elongate endless conveyor chains on the floor extending in a predetermined direction toward the opening;
a door having a surface adapted to be positioned in a closed position in covering relation to at least a lower portion of the opening along the edge portion of the floor, and in an open position extending outwardly in the predetermined direction from the opening at least substantially parallel to the floor, the surface of the door having an end portion including a peripheral edge portion, and a plurality of substantially parallel, elongate endless conveyor chains on the surface of the door extending away from the edge portion of the end portion thereof so as to extend in the predetermined direction when the door is in the open position; and
a combination door pivot and conveyor drive mechanism including an elongate shaft supported on the receiver structure so as to extend at least substantially transversely to the predetermined direction, the shaft connecting the door to the receiver structure for pivotal movement of the door between the closed position and the open position such that when the door is in the closed position the surface of the door will be positioned in adjacent relation to at least a substantial portion of the edge portion of the floor, and such that when the door is in the open position the edge portion thereof will be at least substantially in edge-to-edge relation with the edge portion of the floor, the shaft being supported for rotation about a rotational axis extending longitudinally therethrough, the shaft including sprockets mounted thereon for rotation therewith and being partially encircled by and cooperatively engaged with the conveyors on the floor and on the door, the sprockets being positioned and having about equal diametrical extents such that the conveyor chains on the floor and on the door extend over the edge portions thereof, the conveyor chains on the floor and on the door being longitudinally coextensive over the edge portions thereof, respectively, and a drive connected in driving relation to the shaft and controllably operable for rotating the shaft for simultaneously moving the chains at about an equal speed in the predetermined direction.

12. The receiver of claim 11, wherein the drive is mounted on the door, and the drive is selected from a group consisting of an electric motor and a fluid motor.

13. The receiver of claim 11, wherein the drive is rotatable by the shaft when the door is moved between the closed and open positions thereof.

14. The receiver of claim 11, wherein the end portion of the surface of the door is positioned to be located in closely spaced relation to the edge portion of the floor when moving between the open position and the closed position, for limiting passage and collection of crop material therebetween.

15. The receiver of claim 11, wherein, in the open position, the surface of the door and the floor are substantially coplanar, and the edge portion of the surface of the door includes a bevel for smooth transition of crops moving from the floor to the surface of the door.

16. The receiver of claim 11, wherein the floor and the surface of the door each comprise a low friction polymer material.

17. The receiver of claim 11, wherein the edge portion of the surface of the door includes an upwardly facing bevel for smooth transition of crops moving from the floor to the surface of the door.
